(19) United States
(12) Patent Application Publication
(10) Pub. No.: US 2005/0246928 A1
(43) Pub. Date: Nov. 10, 2005

(54) Illuminating display

(75) Inventor: Seungsoo Lee, Monroe, NJ (US)

Correspondence Address: MCCARTER & ENGLISH, LLP, FOUR GATEWAY CENTER, 100 MULBERRY STREET, NEWARK, NJ, 07102, US

(73) Assignee: Joy World, Inc.

(21) Appl. No.: 11/109,462

(22) Filed: Apr. 19, 2005

Related U.S. Application Data
(60) Provisional application No. 60/563,354, filed on Apr. 19, 2004.
(60) Provisional application No. 60/592,663, filed on Jul. 30, 2004.
(60) Provisional application No. 60/617,853, filed on Oct. 12, 2004.

(51) Int. Cl. G09F 13/04

(52) U.S. Cl. 40/564

(57) ABSTRACT

The present invention relates to an illuminating display device adapted for enhancing amusement for a recipient thereof. More particularly, the device includes a portable case having at least one compartment. The device also includes at least one illuminating source received in the compartment. A stencil is attached to the case for permitting light emitted from the illuminating source to be transmitted therethrough in a predetermined pattern. The device is equipped with a dispersion layer for dispersing light emitted from the illuminating source.

### CROSS-REFERENCE TO RELATED APPLICATIONS

This application claims the benefit of the following three U.S. provisional patent applications, the disclosures of which are incorporated herein by reference in their entirety: U.S. Provisional Patent Application No. 60/563,354 filed Apr. 19, 2004; U.S. Provisional Patent Application No. 60/592,663 filed Jul. 30, 3004; and U.S. Provisional Patent Application No. 60/617,853 filed Oct. 12, 2004.

### FIELD OF THE INVENTION

The present invention relates to illuminating displays and, more particularly, to a display having indicia that can be illuminated.

### BACKGROUND OF THE INVENTION

Various types of illuminating displays have been developed in the past. For instance, there are neon signs, displays having light-emitting diodes (LEDs), electroluminescent displays, liquid-crystal displays, incandescent displays, and candle holders with digital displays (see, for instance, U.S. Pat. Nos. 3,110,837, 3,864,861, 4,229,894, 4,316,337, 4,357,557, 4,373,284, 4,645,970, 4,882,518, 4,999,936, 5,533,289, 5,729,925, 5,780,965, 6,050,010, 6,205,690, 6,226,909, 6,367,179, 6,367,180, 6,422,714, 6,424,088, 6,488,494, 6,501,218, 6,526,681, 6,598,328, 6,624,571, and 6,640,474, 6,732,460 and U.S. Patent Application Publication No. 2005/0030764). While these displays have mechanisms for illuminating indicia mounted or formed thereon, there is a need for an improved illuminating display which enhances amusement for people at gatherings and the like.

### SUMMARY OF THE INVENTION

The present invention overcomes the disadvantages and shortcomings of the prior art discussed above by providing an illuminating display device adapted to enhance amusement for a recipient thereof. More particularly, the display is provided with a case, which includes at least one compartment and at lest one illuminating source received in the compartment. A stencil is provided, having a first area, which permits passage of light therethrough, and a second area, which inhibits passage of light therethrough. A dispersion layer is provided for dispersing light emitting from the illuminating source. In accordance with one feature of the present invention. The dispersion layer includes a substrate coated at least partially with wax.

In one embodiment, the display has a switch which, when operated, causes the illuminating source(s) to alight in a given sequence or all at once. Operating the switch also activates an optional speaker that plays an audible sound (e.g., a musical melody). The display can be provided with support legs such that it can be mounted over a cake (e.g., a birthday cake) with the use of leg members, or can be placed directly on a cake or vertically on a stand. In an alternative embodiment, the display case has a slit into which a greeting card can be inserted. When the greeting card is removed, an associated switch is caused to be in a closed condition for activating the illuminating source and/or speaker so as to generate special effects.

Further features and advantages of the invention will appear more clearly on a reading of the following detailed description of exemplary embodiments of the invention, which are given below by way of example only, with reference to the accompanying drawings.

### BRIEF DESCRIPTION OF THE DRAWINGS

For a more complete understanding of the present invention, reference is made to the following detailed description of exemplary embodiments considered in conjunction with the accompanying drawings, in which:

FIG. 1 is a perspective view of an illuminating display constructed in accordance with a first illustrative embodiment of the present invention;

FIG. 2 is an exploded perspective view of the display shown in FIG. 1;

FIG. 3A is a schematic view of the display shown in FIG. 1, illustrating steps for assembling same;

FIG. 3B is a cross-sectional view of partially assembled components of the display shown in FIG. 1 subsequent to the performance of the steps illustrated in FIG. 3A;

FIG. 4 is a schematic view illustrating how light from an illuminating source within a compartment of the display of FIG. 1 is diffused and emanates through a stencil;

FIGS. 5-7 are views of modified versions of the display shown in FIG. 1;

FIG. 8A is a perspective view of an illuminating display constructed in accordance with a second illustrative embodiment of the present invention;

FIG. 8B is a front view of the illuminating display shown in FIG. 8A;

FIGS. 9A and 9B are schematic views illustrating the operation of an associated switch mechanism utilized in the display of FIGS. 8A and 8B;

FIG. 10 is a perspective view of an illuminating display constructed in accordance with a third illustrative embodiment of the present invention;

FIG. 11 is a top exploded perspective view of the display shown in FIG. 10;

FIG. 12 is a bottom exploded perspective view of the display shown in FIG. 10;

FIG. 13 is an enlarged perspective view of an inner case utilized in the display shown in FIG. 10;

FIG. 14 is an enlarged cross-sectional view, taken along section line 14-14 and looking in the direction of the arrows, of the display shown in FIG. 10;

FIG. 15 is a view similar to FIG. 14, illustrating a modified version of the inner case of the display;

FIG. 16 is a front view of a flower holder assembly constructed in accordance with a fourth illustrative embodiment of the present invention;

FIG. 17 is a rear view of the flower holder assembly shown in FIG. 16;

FIG. 18 is a side view of the flower holder assembly shown in FIG. 16;

FIG. 19 is a perspective view of a candle holder assembly constructed in accordance with a fifth illustrative embodiment of the present invention;

FIG. 20 is a rear view of the candle holder assembly shown in FIG. 19; and

FIG. 21 is a side view of the candle holder assembly shown in FIG. 19.

### DETAILED DESCRIPTION OF THE INVENTION

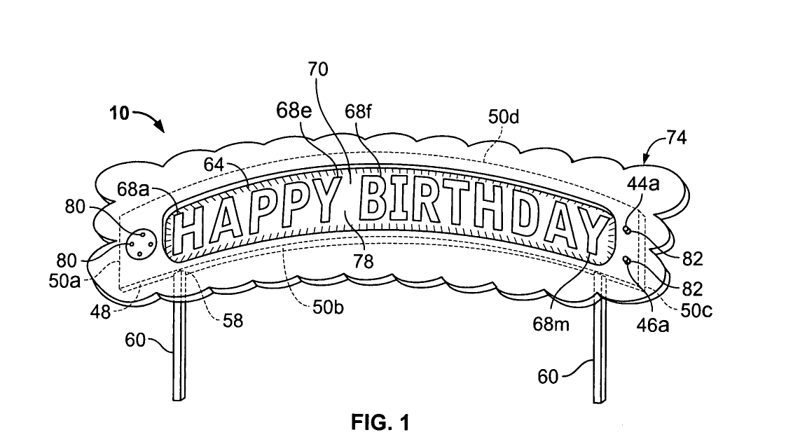

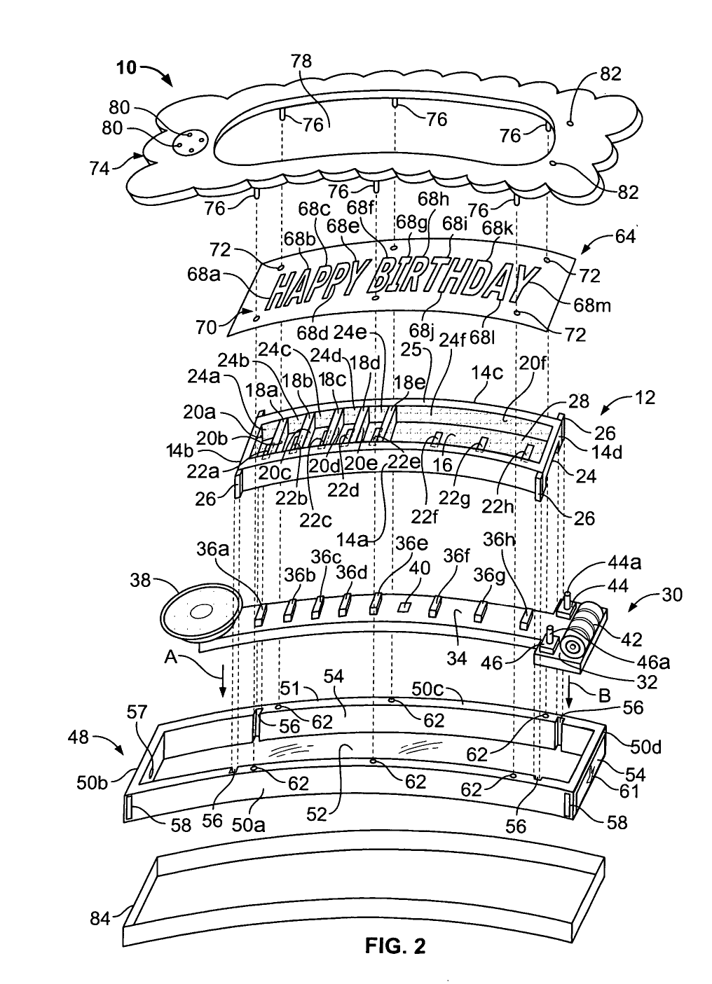

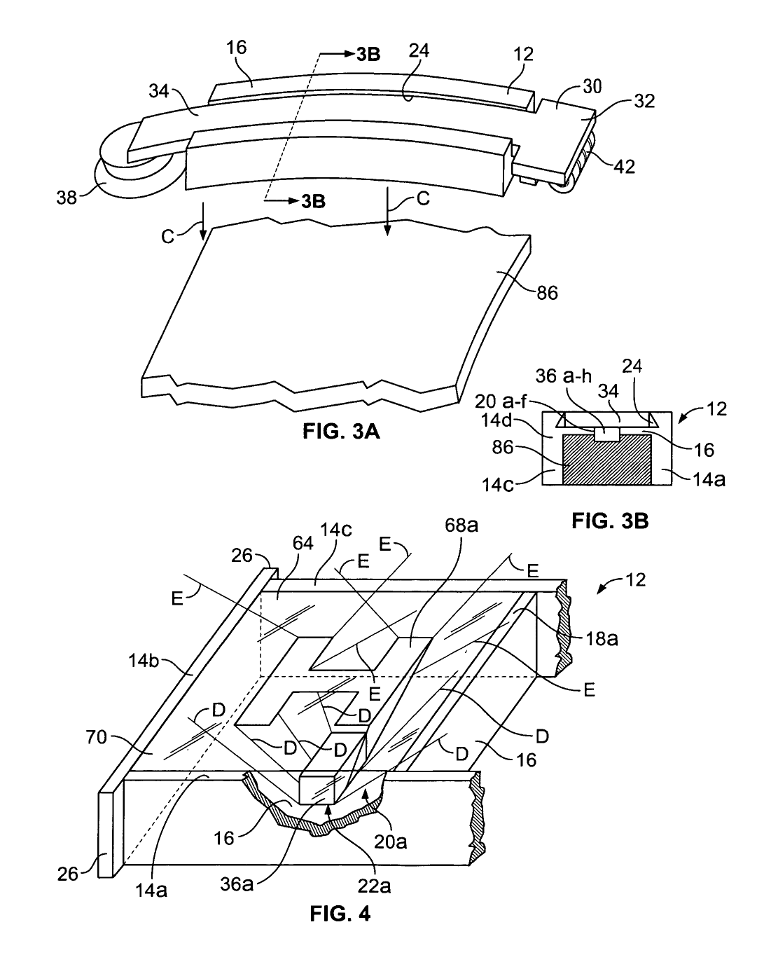

With reference to FIGS. 1 and 2, there is shown an illuminating display 10 constructed in accordance with a first embodiment of the present invention. More particularly, the display 10 includes an inner case 12 having side walls 14a-14d and a bottom wall 16. The inner case 12 is also provided with dividing walls or members 18a-18e extending between the side walls 14a, 14c and projecting from the bottom wall 16. The dividing walls 18a-18e cooperate with the side walls 14a-14d and the bottom wall 16 so as to define a plurality of compartment or chambers 20a-20f. Each of the side walls 14a-14d, the divider walls 18a-18e and the bottom wall 16 is made from an opaque material (or alternatively coated with an opaque material) so as to prevent transmission of light therethrough. The compartments 20a-20e have sizes which are comparable to one another and are provided with holes 22a-22e, respectively, each of which is formed in the bottom wall 16. The compartment 20f, which has a lateral length greater than those of the compartments 20a-20e, has a plurality of holes 22f-22h formed in the bottom wall 16. A channel 24 (see FIGS. 2, 3A and 3B) is also formed in the bottom wall 16, while guiding lips 26 project from the inner case 12 for purposes to be discussed hereinafter.

With reference to FIG. 2, each of the compartments 20a-20f is filled with a light-dispersing material 28 (indicated by the shaded areas in FIG. 2). More particularly, the dispersing materials 28 are adapted to disperse or diffuse light transmitting therethrough for purposes to be discussed hereinafter. Any conventional materials, such as paraffin or other suitable wax, translucent plastic, epoxy, etc., can be used as the light-dispersing materials 28.

Now referring to FIGS. 2 and 3A, the display 10 is equipped with a printed circuit board 30 having an enlarged portion 32 and an elongated portion 34. Light emitting diodes (LEDs) 36a-36h are provided on the elongated portion 34 of the printed circuit board 30. The elongated portion 34 is snap-fitted into the channel 24 of the inner case 12 such that the LEDs 36a-36e extend into the compartments 20a-20e, respectively, through the holes 22a-22e, respectively, of the inner case 12 and such that LEDs 36f-36h extend into the compartment 20f through the holes 22f-22h, respectively (see also FIG. 3B). In order to provide a secure fit between the printed circuit board 30 and the inner case 12, additional fastening mechanism (e.g., screws, glue, etc.) can be used.

Still referring to FIGS. 2 and 3A, a speaker 38 is attached to the elongated portion 34 of the printed circuit board 30 for generating an audible sound. A control unit 40 (shown schematically in FIG. 2) is also provided on the printed circuit board 30. More particularly, the control unit 40, which has a conventional construction and which can therefore include any conventional electrical/electronic components and circuitry, is electrically connected to the LEDs 36a-36h and the speaker 38 for controlling the operation of same. Batteries 42 are mounted on the enlarged portion 32 of the printed circuit board 30 for providing electrical power to the LEDs 36a-36h, the speaker 38 and/or the control unit 40.

An activation switch 44 (see FIG. 2) is mounted on the enlarged portion 32 of the printed circuit board 30 and is electrically connected to the control unit 40. The activation switch 44, which is used to activate the control unit 40, has a push button 44a extending therefrom. When the push button 44a is depressed, the switch 44 sends an electrical signal to the control unit 40 which causes the LEDs 36a-36h to illuminate in a predetermined manner or sequence, while causing the speaker 38 to generate an audible sound (e.g., a musical melody). The control unit 40 is preferably programmed so that the LEDs 36a-36h and the speaker 38 are activated (i.e., the LEDs 36a-36h are illuminated and the speaker 38 generates an audible sound) until the push button 44a is subsequently depressed. Alternatively, the control unit 40 can be programmed so that the LEDs 36a-36h and the speaker 38 are automatically deactivated after the expiration of a predetermined time period.

A test switch 46 (see FIG. 2) is mounted on the enlarged portion 32 of the printed circuit board 30 and is connected to the control unit 40. The test switch 46 has a push button 46a projecting therefrom. The test switch 46 is adapted for use by consumers for testing the operation of the display 10 prior to purchasing the display 10. More particularly, the display 10 can be packaged in a package such that the push button 46a is exposed. In this manner, a buyer can depress the push button 46a and observe the operation of the display 10. The control unit 40 can be programmed so that when the test switch 46 is activated by the depression of the push button 46a, the control unit 40 activates the LEDs 36a-36h and the speaker 38 for a preset time period and then automatically deactivates same after the expiration of such a time period.

The illustrative embodiments of the present invention are not limited to printed circuit boards with LEDs, switches, speakers, and batteries mounted thereon. In other embodiments, one or more of the LEDs 36a-36h, the switches 44, 46, the speaker 38, and the batteries 42 can be placed inside the inner case 12 with wiring from these elements passing through the inner case 12 to a source of electrical control outside the inner case 12. In still other embodiments of the present invention, all electronic devices, including the printed circuit board 30, can be placed inside the inner case 12.

Referring to FIG. 2, the display 10 has an outer case 48. The outer case 48 has a plurality of side walls 50a-50d and a bottom wall 52, which cooperate so as to define a chamber 54. The inner case 12 and the printed circuit board 30 are received in the chamber 54 of the outer case 48 such that open sides of the compartments 20a-20f of the inner case 12 (i.e., the sides of the compartments 20a-20f opposite the bottom wall 16) are substantially aligned with an open side of the chamber 54 (i.e., the side of the chamber 54 opposite the bottom wall 52). The outer case 48 has a plurality of slots 56 which are formed in the side walls 50a, 50c. Each of the slots 56 receives a corresponding one of the lips 26 of the inner case 12 (as indicated by arrows A and B in FIG. 2) so as to secure the inner case 12 and hence the printed circuit board 30 within the outer case 48. The inner case 12 and the printed circuit board 30 can be further secured to the outer case 48 with the use of glue, screws or other fastening mechanisms. The outer case 48 also includes a hole 57 formed in the side wall 50b for aiding the transmission of sound emanating from the speaker 38. Openings 58 are formed in the side wall 50a of the outer case 48. More particularly, each of the openings 58 is sized and shaped so as to receive a leg member 60 (see FIG. 1). The leg members 60 are adapted to be inserted into a cake such that the display 10 can be supported above same in a vertical orientation like a banner. The side wall 50d, which is positioned adjacent to the batteries 42, is provided with a removable cover 61 such that the batteries 42 can be removed and replaced with replacement batteries. Further, mounting holes 62 are formed in the side walls 50a, 50c for purposes to be discussed hereinafter.

Still referring to FIG. 2, a stencil 64 is mounted to the open side of the outer case 48 such that it directly overlies the inner case 12 (see also FIG. 4). More particularly, the stencil 64 has a plurality of transparent areas 68a-68m, each of which has a shape of a pre-selected letter (e.g., “H”, “A”, “P”, etc.) such that the transparent areas 68a-68m cooperate to form words or phrases (e.g., “HAPPY BIRTHDAY”, “HAPPY ANNIVERSARY”, “MERRY CHRISTMAS”, etc.) on the stencil 64. The stencil 64 can be made from any suitable material (e.g., plastic). The stencil 64 is also provided with an opaque area 70 surrounding the transparent areas 68a-68m. The opaque area 70 can be coated, applied or painted with any material (e.g., a black or silver paint) which substantially blocks transmission of light therethrough such that light is permitted to pass through the stencil 64 only through the transparent areas 68a-68m. The stencil 64 is positioned relative to the inner case 12 such that the transparent areas 68a-68e directly overlie the compartments 20a-20e, respectively, of the inner case 12 and such that the transparent areas 68f-68m directly overlie the compartment 20f of the inner case 12. As a result, the LEDs 36a-36e, which are received in the compartment 20a-20e, respectively, individually “illuminate” the transparent areas 68a-68e, respectively, which form the word HAPPY. Similarly, the LEDs 36f-36h, all of which are received in the single compartment 20f, are adapted to collectively “illuminate” the transparent areas 68f-68m which form the word BIRTHDAY. The transparent areas 68a-68m can be made from the same material as the rest of the stencil 64 (e.g., the stencil 64 can be made by providing a transparent plastic sheet and applying same with an opaque material so as to form the transparent areas 68a-68m). Alternatively, the transparent areas 68a-68m can be defined by slots formed in the stencil 64 (e.g., the stencil 64 can be formed by providing an opaque sheet and forming slots therein so as to define the transparent areas 68a-68m). The stencil 64 is also provided with a plurality of mounting holes 72 for purposes to be discussed hereinafter.

With reference to FIGS. 1 and 2, a cover 74 having decorations is mounted over the stencil 64 and fastened to the outer case 48. The cover 74 has posts 76 which project therefrom and each of which is inserted into a corresponding one of the mounting holes 62 of the outer case 48. In this manner, the cover 74 is securely attached to the outer case 48, thereby retaining the inner case 12 and the printed circuit board 30 within the chamber 54 of the outer case 48. In addition, each of the posts 76 extends through a corresponding one of the mounting holes 72 of the stencil 64 such that the stencil 64 is affixed to the outer case 48 and is thereby maintained in proper alignment relative to the inner case 12 and hence the compartments 20a-20f. The cover 74 has an opening 78 formed therein so that the transparent areas 68a-68m of the stencil 64 are exposed and are therefore visible through the opening 78. The cover 74 can be made from any suitable material, such as plastic. The bottom surface of the cover 74 can be coated with an opaque material so as to prevent light emitted by the LEDs 36a-36h from passing through the cover 74. The cover 74 also has a plurality of sound-transmission holes 80 located adjacent to the speaker 38 such that an audible sound generated by the speaker 38 can be transmitted outwardly through the holes 80. Orifices 82 are also formed in the cover 74 such that the push buttons 44a, 46b of the switches 44, 46, respectively, extend outwardly therethrough (see FIG. 1).

Now referring to FIG. 2, an optional tray 84 can also be provided. More particularly, the tray 84, which can be a blister made of thin plastic in the shape of the bottom of the outer case 48, can be placed on a cake, such as a birthday cake, such that the display 10 can be placed thereon when it is desirable to place the display 10 flat directly on the cake. In such use, the leg members 60 would be detached from the display 10. Because the display 10 contains sensitive electronic components, it is preferable to avoid washing the display 10. With the use of the tray 84, the user needs to wash only the tray 84 after using the display 10. When the display 10 is placed over a cake in a vertical orientation with the use of the optional leg members 60 (see FIG. 1), the tray 84 is not used.

With reference to FIG. 3A, the display 10 can preferably be assembled in the following manner. The printed circuit board 30 is snap-fitted into the channel 24 of the inner case 12, thereby securing the printed circuit board 30 to the inner case 12. The printed circuit board/case assembly is then placed upside-down facing a block or strip 86 of wax (e.g., paraffin wax) having a height that is substantially equal to the depth or height of the compartments 20a-20f. The wax block 86 is then heated such that it has a softened viscosity, i.e. semi-solid. Next, the printed circuit board/case assembly is pressed into the wax block 86 (as indicated by arrows C in FIG. 3A), thereby causing each of the compartments 20a-20f to be filled with wax. The wax is then allowed to solidify inside each compartment 20a-20f. The printed circuit board/case assembly filled with wax is shown in FIG. 3B in cross-section. The printed circuit board/case assembly is then removed from the wax block 86 and then assembled with the remaining components of the display 10 discussed above. Alternatively, rather than using the wax block 86, liquid wax can be poured into each compartment 20a-20f and allowed to solidify (with the inner case 12 facing up).

In use, when the push button 44a is depressed, the control unit 40 of the printed circuit board 30 energizes the LEDs 36a-36h such that each letter or group of letters formed by the transparent areas 68a-68m is illuminated or flashes in a predetermined sequence. The control unit 40 also causes the speaker 38 to generate an audible sound (e.g., a musical melody). The LEDs 36a-36h and the speaker 38 are deactivated by depressing the push button 44a one more time. When the push button 46a of the test switch 46 is depressed, a test pattern of the LEDs 36a-36h is displayed and a sample of music is played via the speaker 38 for the purpose of allowing buyers to try the display 10 before purchasing.

With reference to FIG. 4, how light is transmitted through the display 10 is illustrated therein in connection with the LED 36a. As discussed above, the LED 36a is located at the bottom of the compartment 20a, surrounded by the side walls 14a-14c, the dividing wall 18a and the bottom wall 16. When the LED 36a is illuminated, the dispersing material 28 diffuses or disperses light produced by the LED 36a throughout the compartment 20a (as indicated by arrows D in FIG. 4). The side walls 14a-14c, the dividing wall 18a and the bottom wall 16 are opaque and therefore do not permit transmission of light therethrough. Likewise, the opaque portion 70 of the stencil 64 covering the compartment 20a inhibits light from escaping therethrough. As a result, light is permitted to be dispersed outwardly only through the transparent area 68a of the stencil 64 (as indicated by arrows E in FIG. 4), thereby providing the appearance of a fully illuminated letter.

The present invention provides numerous advantages over the prior art. For instance, due to the use of paraffin wax as the light-dispersing materials 28, the display 10 can be manufactured in a cost-effective manner. Moreover, because of its simple design, the display 10 can be assembled easily. In addition, having five smaller compartments 20a-20e followed by a single larger compartment 20f makes it easier to replace “BIRTHDAY” in stencil 64 with any other word and to replace “HAPPY” with another five letter word such as “MERRY” without having to manufacture another inner case 12 with a different number of compartments.

The display 10 of the present invention can have numerous modifications and variations. For instance, the stencil 64 can be formed integrally with, or as part of, other parts of the display 10 (e.g., the cover 74, the outer case 48 or the inner case 12). In addition, the stencil 64 can be in any form, structure, shape, and/or size (e.g., it can be in the form of a panel, board, etc.) so long as it permits light to pass therethrough in a predetermined pattern. Moreover, the entire back side of the stencil 64 can be coated with a light-dispersing material (e.g., wax), or be applied with a sheet made out of a light-dispersing material (e.g., a thin wax-coated or wax soaked paper or a translucent sheet of plastic sandwiched between the stencil 64 and the inner case 12), thereby obviating the need to fill the compartments 20a-20f with the light-dispersing material 28. The light-dispersing material 28 can also be eliminated by modifying the transparent areas 68a-68m of the stencil 64 such that they themselves provide a light-dispersing effect. For instance, the transparent areas 68a-68m can be embossed or scratched or can be engraved with fine dots such that light passing therethrough becomes dispersed directly by the areas 68a-68m. Such embossing, scratching or engraving can be performed on either surface of the areas 68a-68m (i.e., either side of the stencil 64). The embossed, scratched or engraved surface or surfaces of the stencil 64 therefore defines a light-dispersing area or areas. The light-dispersing area or areas can be positioned between the stencil 64 and the LEDs 36a-36h (e.g., when the light-dispersing area or areas is located on a side of the stencil 64 proximate the LEDs 36a-36h), or the stencil 64 can be positioned between the light-dispersing area or areas and the LEDs 36a-36h (e.g., when the light dispersing area or areas is located on a side of the stencil 64 opposite the LEDs 36a-36h).

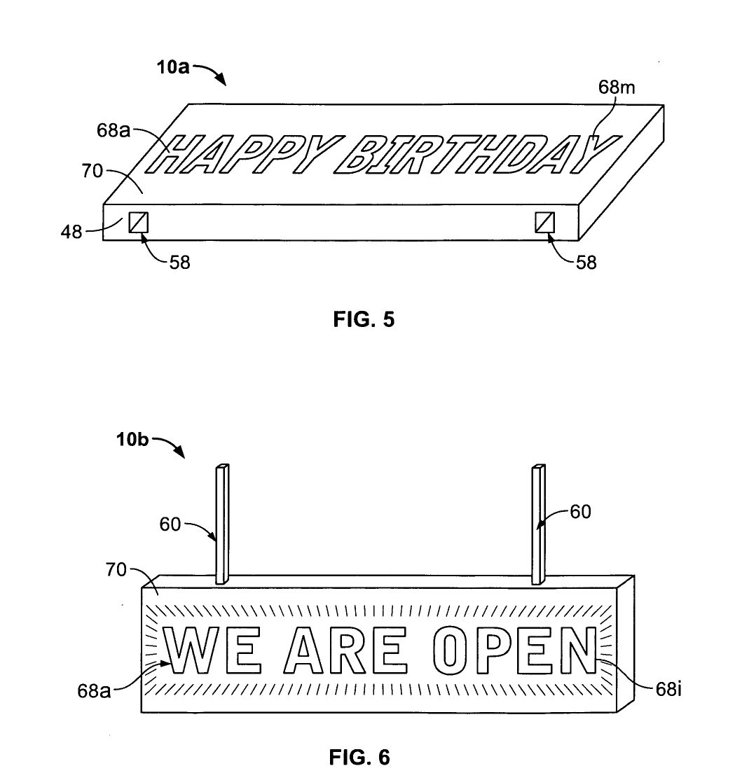

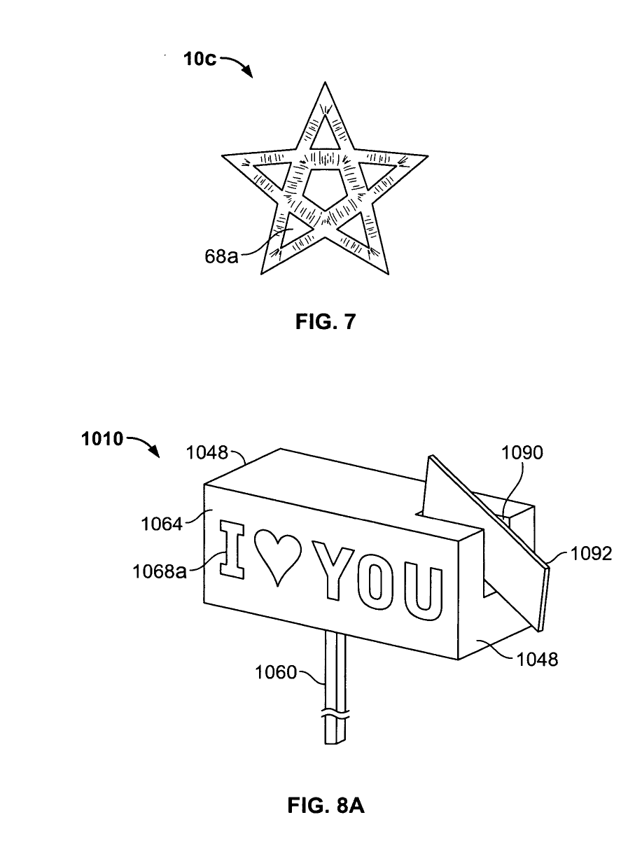

While the display 10 is depicted in FIGS. 1 and 2 as having a curved shaped, it can have any shapes and sizes. For instance, FIG. 5 depicts a variation of the display 10a that is rectangular in shape without any leg members such that it can be placed flat or horizontally on a cake surface or other supporting surfaces. In FIG. 6, an illuminating display 10b hangs vertically via supporting beams 60 from the top of a window (not shown) through which illuminating display 10b can be seen, with illuminated letters facing the outside the window for customers to see (i.e., the display 10b can be used as a store display or sign). FIG. 7 shows a display 10c having pictures or geometric or non-geometric elements 68 that can be illuminated. The display 10c of FIG. 7 is especially suitable for use as a Christmas tree ornament.

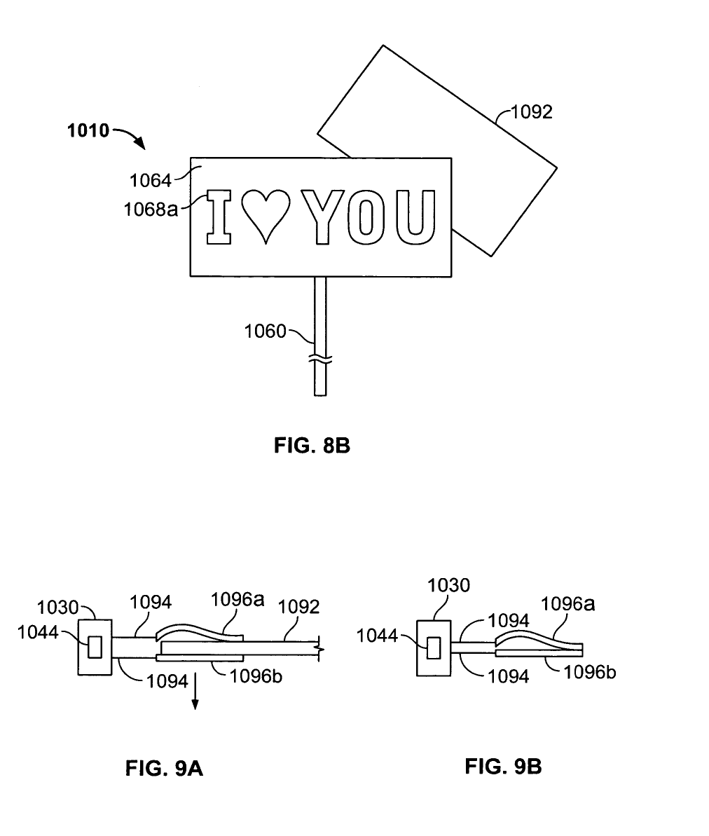

FIGS. 8A-9B illustrate a second embodiment of the present invention. Elements illustrated in FIGS. 8A-9B, which correspond, either identically or substantially, to the elements described above with respect to the embodiment of FIGS. 1 and 2, have been designated by corresponding reference numerals increased by one thousand. Unless otherwise stated, the embodiment of FIGS. 8A-9B is constructed and assembled and operates in the same basic manner as the embodiment of FIGS. 1 and 2.

With reference to FIGS. 8A-9B, there is shown a display 1010 constructed in accordance with a second embodiment of the present invention. More particularly, the display 1010 is suitable for use as a greeting card holder which can be assembled or packaged with a bouquet. The display 1010 has an outer case 1048 and a stencil 1064 having transparent areas 1068. A slot 1090 is formed in one side of the outer case 1048 for receiving a greeting card 1092. The display 1010 is adapted to display phases such as “Thank You”, “Congratulations” and “I Love You”.

Referring to FIGS. 9A and 9B, a switch 1044 is mounted within the outer casing 1048. More particularly, the switch 1044 performs the same function as the switch 44 of the embodiment shown in FIGS. 1 and 2 (i.e., causing the display 1010 to illuminate and/or generate an audible sound). The switch 1044 resides on a printed circuit board 1030 and is electrically connected via conductors 1094 to clip switch contacts 1096a and 1096b positioned in the slot 1090. The switch contacts 1096a and 1096b replace the push button 44a of the switch 44 of the embodiment shown in FIGS. 1 and 2. With reference to FIG. 9A, when inserted in the slot 1090, the card 1092, which is non-conductive, is positioned between the switch contacts 1096a, 1096b such that the switch 1044 is in its “off” position. When the card 1092 is removed from the slot 1090 (see FIG. 9B), the switch contacts 1096a, 1096b come in contact with one another, thereby completing a circuit via the conductors 1094 to the switch 1044 on the printed circuit board 1030. The switch 1044, being in its “on” position, then causes LEDs within the display 1010 to flash in a predetermined sequence and/or an associated speaker to play a melody for a predetermined time. Other types of switch mechanisms (e.g., a photo sensor-type switch, a motion detector-type switch or other types of mechanical switches) can be utilized for activating the display 1010.

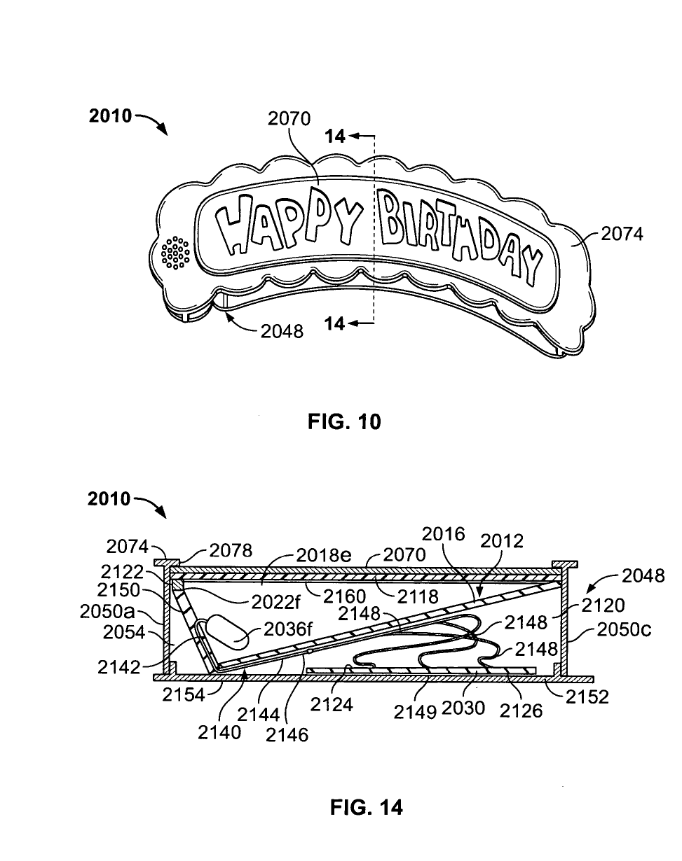

FIGS. 10-14 illustrate a third embodiment of the present invention. Elements illustrated in FIGS. 10-14, which correspond, either identically or substantially, to the elements described above with respect to the embodiment of FIGS. 1 and 2, have been designated by corresponding reference numerals increased by two thousand. Unless otherwise stated, the embodiment of FIGS. 10-14 is constructed and assembled and operates in the same basic manner as the embodiment of FIGS. 1 and 2.

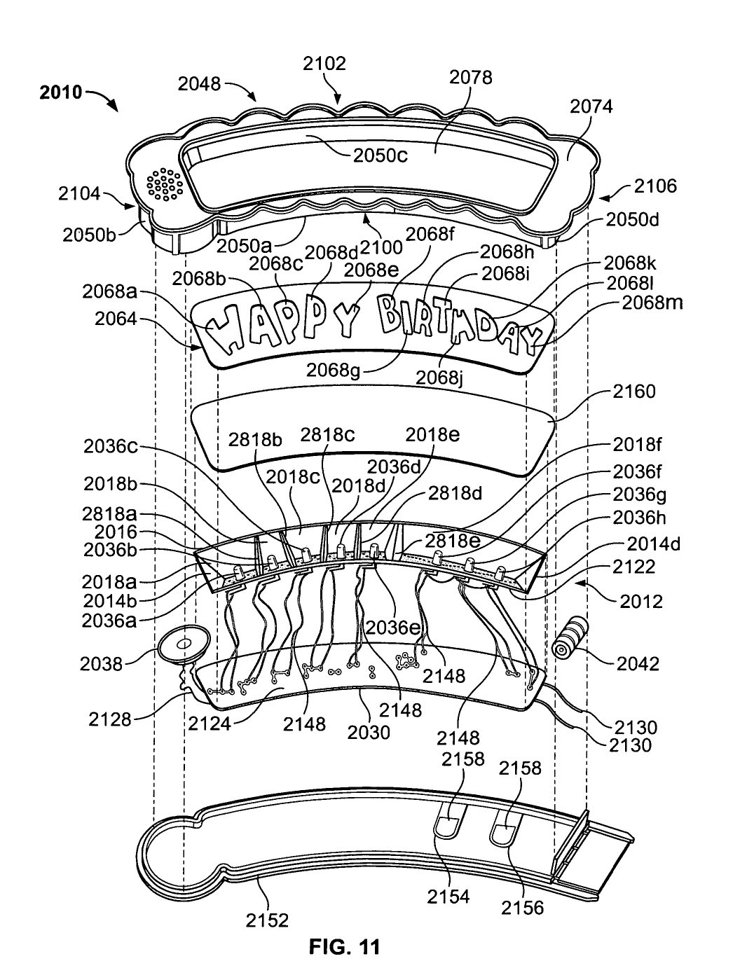

With reference to FIGS. 10-12, there is shown a display 2010 constructed in accordance with a third embodiment of the present invention. The display 2010 includes an outer case 2048, which is provided with a cover 2074 formed integrally (i.e., monolithically) therewith and having an opening 2078. The outer case 2048, which has a pair of transverse sides 2100, 2102 (see FIG. 11) and a pair of lateral sides 2104, 2106 (see FIG. 11), is equipped with a chamber 2054 therein and an open bottom end 2108 such that various components of the display 2010 can be placed into the chamber 2054 through the open bottom end 2108. Sidewalls 2050a-2050d project downwardly from the cover 2074 and cooperate with the cover 2074 in defining the chamber 2054, as well as the open bottom end 2108.

Referring to FIGS. 11-13, the display 2010 is also provided with an inner case or a frame 2012 having a pair of transverse sides 2110, 2112 and a pair of lateral sides 2114, 2116. The inner case 2012 is housed in the chamber 2054 of the outer case 2048 and includes a base 2016 and ribs 2014b, 2014d projecting upwardly from the base 2016 along the lateral sides 2114, 2116, respectively. Ribs 2018a-2018e also project upwardly from the base 2016 and extend between the transverse sides 2110, 2112 of the inner case 2012. The ribs 2014b, 2014d, 2018a-2018e cooperate with the base 2016 so as to define a plurality of compartments or chambers 2020a-2020f. Like the compartment 20f of the embodiment shown in FIG. 2, the compartment 2020f of the display 2010 is provided with a lateral length greater than those of the compartments 2020a-2020e.

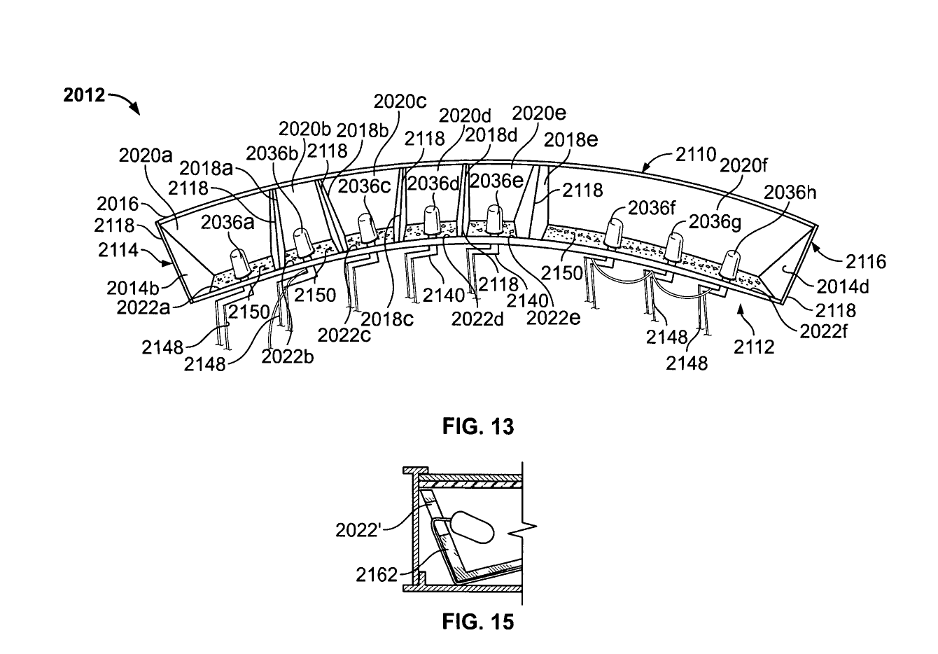

With reference to FIGS. 13 and 14, the ribs 2014b, 2014d, 2018a-2018e are provided with substantially straight upper sides 2118 which are aligned vertically with respect to one another such that the inner case 2012 can be received in the chamber 2054 of the outer case 2048 with the upper sides 2118 facing against or toward the cover 2074 of the outer case 2048 (see FIG. 14). Each of the ribs 2014b, 2014d, 2018a-2018e is also provided with an increasing height as it extends from the transverse side 2112 to the transverse side 2110 (i.e., the height of each of the ribs 2014b, 2014d, 2018a-2018e adjacent the transverse side 2110 is greater than the height of same adjacent the transverse side 2112). In this manner, the base 2016 can be positioned in a slanted orientation so as to form a space 2120 therebelow (see FIG. 14) for purposes to be discussed hereinafter.

Now referring to FIGS. 11, 13 and 14, a reinforcing member 2122 extends between the lateral sides 2114, 2116 of the inner case 2012 along the transverse side 2110 and is connected to the ribs 2014b, 2014d, 2018a-2018e. More particularly, the reinforcing member 2122 is spaced upwardly from the base 2016 such that lateral holes 2022a-2022f are formed along the transverse side 2110 of the inner case 2012 (see FIGS. 13 and 14). Each of the lateral holes 2022a-2022f, which are aligned with the compartments 2020a-2020f, respectively, is defined by the reinforcing member 2122, the base 2016 and a corresponding set of the ribs 2014b, 2014d, 2018a-2018e.

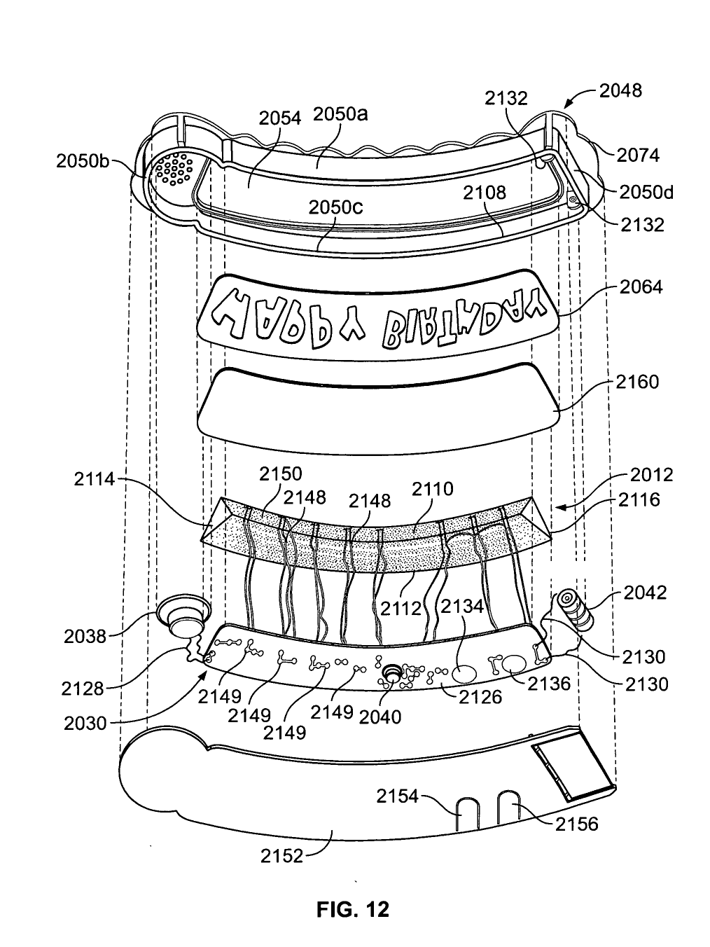

The display 2010 is also equipped with a printed circuit board 2030 (see FIGS. 11, 12 and 14) and LEDs 2036a-2036h (see FIGS. 11-14) which are electrically connected to the printed circuit board 2030. More particularly, the printed circuit board 2030, which has an upper side 2124 and a lower side 2126, is positioned in the outer case 2048 in the space 2120 formed below the base 2016 of the inner case 2012. A control unit 2040 (see FIG. 12) and additional electrical and/or electronic components (not shown) are provided on the lower side 2126 of the printed circuit board 2030 for controlling the operation of the LEDs 2036a-2036h. A speaker 2038 is electrically connected to one end of the printed circuit board 2030 via electrical wires 2128, while batteries 2042 are electrically connected to the printed circuit board 2030 via electrical wires 2130 and a pair of contacts 2132 located in the outer case 2048 (see FIG. 12). The speaker 2038 and the batteries 2042 are mounted in the chamber 2054 of the outer case 2048 adjacent the lateral sides 2104, 2106 thereof, respectively. The lower side 2126 of the printed circuit board 2030 is also provided with a contact or contacts 2134 (see FIG. 12) and a contact or contacts 2136 (see FIG. 12) for purposes to be discussed hereinafter.

Referring back to FIGS. 11, 13 and 14, the LEDs 2036a-2036h are affixed to the inner case 2012. More particularly, the LEDs 2036a-2036e project into the compartments 2020a-2020e, respectively, through the lateral holes 2022a-2022e, respectively, while LEDs 2036f-2036h project into the compartment 2020f through the lateral hole 2022f. Each of the LEDs 2036a-2036h has semi-rigid conductive leads 2140 for supplying electrical power thereto. More particularly, each of the leads 2140 has a portion 2142 (see FIG. 14) extending in a generally downward direction from the corresponding LED 2036a-2036h to the base 2016, as well as a portion 2144 (see FIG. 14) which is bent relative to the portion 2142 such that it is generally parallel to the base 2016. The portion 2144 of each of the leads 2140 has an end 2146 which is secured (e.g., soldered) to the base 2016 for anchoring the leads 2140 to same. The end 2146 of each lead 2140 is connected to an electrical wire 2148 which is connected to printed circuits (not shown) provided on the lower side 2126 of the printed circuit board 2030. More particularly, an end of each wire 2148 extends through the printed circuit board 2030 from the upper side 2124 to the lower side 2126 and is connected to the printed circuits via electrical connections 2149 formed on the lower side 2126 (see FIGS. 12 and 14).

Referring to FIGS. 11 and 14, the electrical wires extending to or from the printed circuit board 2030, such as the wires 2128, 2130, 2148, are folded and/or positioned between the base 2016 of the inner case 2012 and the upper side 2124 of the printed circuit board 2030 (see FIG. 14). Because the wires 2128, 2130 and/or 2148 are semi-rigid, they provide the printed circuit board 2030 with sufficient stability such that the printed circuit board 2030 can be housed in the outer case 2048 without the use of a separate anchoring mechanism (e.g., the groove 24 of the inner case 12 shown in FIG. 2). In other words, the wires 2128, 2130 and/or 2148 at least partially secure the printed circuit board 2030 within the outer case 2048.

Each lateral hole 2022a-2022f is filled with an adhesive material 2150, such as glue. More particularly, the adhesive material 2150 is applied to each of the lateral holes 2022a-2022f such that the portions 2142 of the leads 2140 of the corresponding LED 2036a-2036h are embedded therein so as to secure and maintain the LED in a desired orientation (e.g., in a generally downward position as shown in FIG. 14). The adhesive materials 2150 also function to inhibit light emitted from the LEDs 2036a-2036h from escaping through the lateral holes 2022a-2022f.

With reference to FIGS. 10-13, the display 2010 has a bottom cover 2152 for closing off the open bottom end 2108 of the outer case 2048. The bottom cover 2152 includes a pair of movable tabs 2154, 2156, each of which is provided with an electrically conductive layer 2158 for engaging a corresponding one of the contacts 2134, 2136 provided on the lower side 2126 of the printed circuit board 2030. When the contacts 2134, 2136 come in contact with the conductive layers 2158 of the movable tabs 2154, 2156, respectively, the controller unit 2040 causes the LEDs 2036a-2036h to illuminate in predetermined fashion and causes the speaker 2038 to generate audible sounds. Accordingly, the tabs 2154, 2156 and the contacts 2134, 2136, respectively, function as the activation switch 44 and the test switch 46 of the embodiment illustrated in FIGS. 1 and 2.

Referring specifically to FIGS. 11 and 12, the display 2010 is provided with a stencil 2064 which is constructed in the same basic manner as the stencil 64 of the embodiment illustrated in FIGS. 1 and 2. More particularly, the stencil 2064 has a plurality of areas 2068a-2068m which permit passage of light therethrough and each of which has a predetermined shape (e.g., a shape of a pre-selected letter, such as “H”, “A”, “P”, etc.). The stencil 2064 is captured between the inner case 2012 and the cover 2074 of the outer case 2048 (see FIG. 14) such that each of the areas 2068a-2068m is aligned with a corresponding one of the compartment 2020a-2020f of the inner case 2012.

Rather than filling the compartments 2020a-2020f of the inner case 2012 with a light-dispersing material (e.g., paraffin wax), the display 2010 is provided with a light-dispersing substrate 2160 (see FIGS. 11, 12 and 14) positioned between the stencil 2064 and the inner case 2012. The substrate 2160 can be formed in numerous ways so long as it functions to at least partially scatter or disperse light as it passes through the substrate 2160. For instance, the substrate 2160 can be formed by dipping a sheet of paper in a suitable light-dispersing material (e.g., a paraffin wax) so as to form a light-dispersing layer or layers thereon or therein. Alternatively, the entire substrate can be made from a translucent or other light-dispersing material (e.g., a translucent plastic). In this manner, when light passes through the substrate 2160 and then the stencil 2064, the areas 2068a-2068m of the stencil 2064 appear to be fully illuminated.

It should be appreciated that the display 2010 provides additional advantages. For instance, the provision of the light-dispersing substrate 2160 eliminates the need to fill the compartments 2020a-2020f with a light-dispersing material, hence minimizing the time required to make/assembly the display 2010. Moreover, because the LEDs 2036a-2036h are inserted into the inner case 2012 laterally through the lateral holes 2022a-2022f (rather than vertically through the holes 22a-22f formed on the bottom wall 16 of the inner case 12 shown in FIG. 2), the overall thickness of the display 2010 is reduced, thereby providing the display 2010 with a more streamlined appearance. The construction of the inner case 2012 further contributes to the reduction of the overall thickness of the display 2010. For instance, because of the slanted construction of the base 2016 of the inner case 2012, the space 2120 (see FIG. 14) is formed below the base 2016 for accommodating the printed circuit board 2030 without increasing the overall thickness of the display 2010.

The display 2010 of the present invention can have numerous modifications and variations. For instance, the light-dispersing substrate 2160 can be combined with the stencil 2064 as a single unit. By way of example, a sheet (i.e., the substrate 2160) of paper can be coated with a light-blocking material so as to form opaque areas and transparent/translucent areas thereon such that light can pass through the sheet only through the transparent/translucent areas. The sheet can then be soaked in a light-dispersing material (e.g., wax) to provide same with a light-dispersing characteristic. Prior to or after soaking the sheet in the light-dispersing material, it can be applied with additional coatings of suitable materials so as to provide same with colors, to enhance its appearance (e.g., to provide a shinny look), to strengthen its structure (e.g., by applying same with a plastic-like material).

Since the compartments 2020a-2020f of the inner case 2012 are hollow, the stencil 2064 can collapse when a downward force is applied thereto (e.g., when a user inadvertently presses down onto the stencil 2064 with his/her finger). To prevent such collapsing, supporting columns can be provided in one or more of the compartments 2020a-2020f. The compartments 2020a-2020f can also have any suitable sizes and shapes depending upon application needs and requirements.

The inner case 2012 can also be modified in many different ways. For instance, a side wall 2162 (see FIG. 15) can extend along the transverse side 2110 of the inner case 2012, incorporating smaller sized holes 2022′ for permitting the insertion of the LEDs 2036a-2036h into the compartments 2020a-2020f therethrough. Once the LEDs 2036a-2036h have been inserted into the compartments 2020a-2020f through the smaller sized holes 2022′, they can be secured to the inner case 2012 with the use of adhesive (e.g., glue).

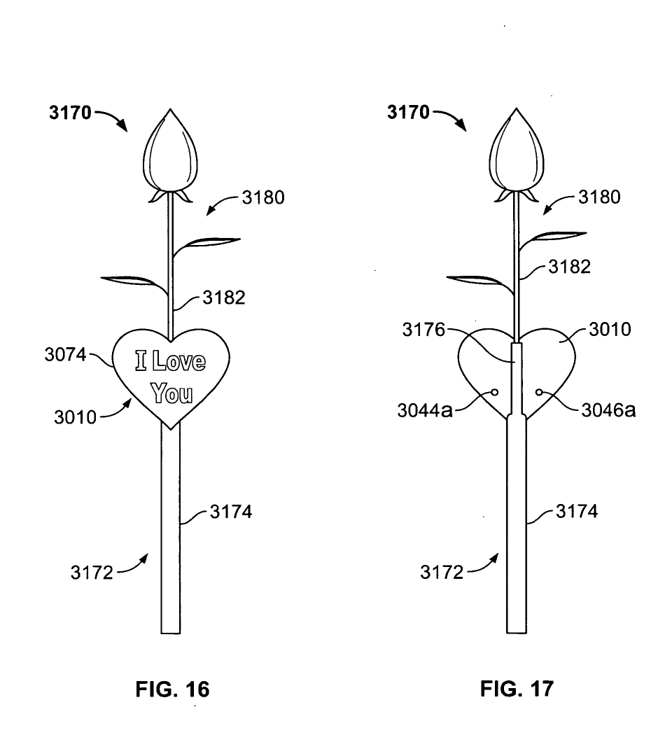

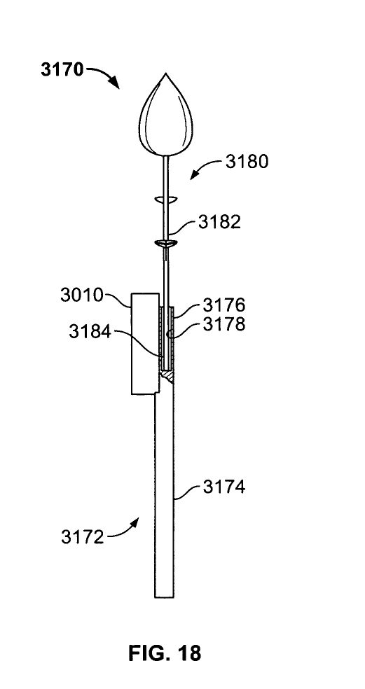

FIGS. 16-18 illustrate a fourth embodiment of the present invention. Elements illustrated in FIGS. 16-18, which correspond, either identically or substantially, to the elements described above with respect to the embodiment of FIGS. 1 and 2, have been designated by corresponding reference numerals increased by three thousand. Unless otherwise stated, the embodiment of FIGS. 16-18 is constructed and assembled and operates in the same basic manner as the embodiment of FIGS. 1 and 2.

With reference to FIGS. 16-18, there is shown a flower holder assembly 3170 constructed in accordance with a fourth embodiment of the present invention. The flower holder assembly 3170 includes a flower holder 3172 having a handle section 3174 adjacent a lower end thereof. The handle section 3174 is sized and shaped so as to be held by a user's hand. A receptacle 3176 extends upwardly from the handle section 3174 and includes an opening 3178 for purposes to be discussed hereinafter.

The flower holder assembly 3170 is adapted for holding a flower 3180 having a stem 3182. More particularly, the opening 3178 of the receptacle 3176 is sized and shaped so as to receive an end 3184 of the stem 3182 such that the flower 3180 can be supported from the flower holder 3172. The end 3184 of the stem 3182 can be received loosely, and hence removably, in the receptacle 3176. Alternatively, the end 3184 of the stem 3182 can be fixedly mounted in the receptacle 3176 by adhesive. Further, the opening 3178 of the receptacle 3176 can be sized such that the end 3184 of the stem 3182 is secured therein by way of a friction or interference fit. The flower 3180 can be either a natural or artificial flower. For use with natural flowers, the receptacle 3176 can be modified so as to contain water and/or ingredient/chemical used in the flower industry to prolong the freshness of flowers.

An illuminating display 3010 is affixed to the flower holder 3172. More particularly, the display 3010 is constructed and operates in the same basic manner as the embodiments discussed above except as discussed hereinbelow. The display 3010 can be formed as a monolithic component of the flower holder 3172 (e.g., the housing of the display 3010 can be molded together with the flower holder 3172) or as a separate component securely attached to the flower holder 3172. The display 3010 has an activation switch button 3044a and a test switch button 3046a extending from a rear side of the display 3010 in a rearward direction (see FIG. 17). The display 3010 is also provided with a cover 3074 having a “heart” shape and is adapted to illuminate a romantic phrase, such as “I LOVE YOU”. Alternatively, the display 3010 can be provided with another shape or be adapted to illuminate a different phrase. With the addition of the display 3010 to the flower holder 3172, the flower holder assembly 3170 is adapted to enhance amusement when it is presented to a recipient.

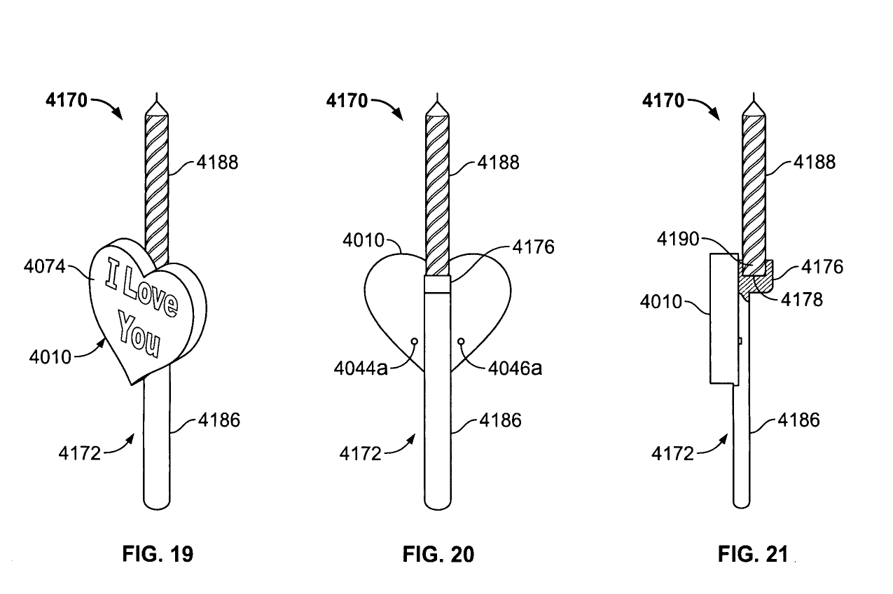

FIGS. 19-21 illustrate a fifth embodiment of the present invention. Elements illustrated in FIGS. 19-21, which correspond, either identically or substantially, to the elements described above with respect to the embodiment of FIGS. 1 and 2, have been designated by corresponding reference numerals increased by four thousand. Unless otherwise stated, the embodiment of FIGS. 19-21 is constructed and assembled and operates in the same basic manner as the embodiment of FIGS. 1 and 2.

With reference to FIGS. 19-21, there is shown a candle holder assembly 4170 constructed in accordance with a fifth embodiment of the present invention. The candle holder assembly 4170 includes a candle holder 4172 having a lower end 4186 which is sized and shaped so as to be inserted into a cake (not shown) for supporting the candle holder 4172 thereon. A receptacle 4176 extends upwardly from the candle holder 4172 and includes an opening 4178.

The candle holder 4172 is adapted for holding a candle 4188. More particularly, the opening 4178 of the receptacle 4176 is sized and shaped so as to receive an end 4190 of the candle 4188 such that the candle 4188 can be supported from the candle holder 4172. The opening 4178 of the receptacle 4176 is sized and shaped such that the end 4190 of the candle 4188 is secured therein by way of a friction or interference fit, thereby allowing the candle 4188 to be removed from the candle holder 4172.

An illuminating display 4010 is affixed to the candle holder 4172. More particularly, the display 4010 is constructed and operates in the same basic manner as the embodiments discussed above except as discussed hereinbelow. The display 4010 can be formed as a monolithic component of the candle holder 4172 (e.g., the housing of the display 4010 can be molded together with the candle holder 4172) or as a separate component securely attached to the candle holder 4172. The display 4010 has an activation switch button 4044a and a test switch button 4046a extending from a rear side of the display 4010 in a rearward direction (see FIGS. 20 and 21). The display 4010 is also provided with a cover 4074 having a “heart” shape and is adapted to illuminate a romantic phrase, such as “I LOVE YOU”. Alternatively, the display 4010 can be provided with another shape or be adapted to illuminate a different phrase.

It will be understood that the embodiments described herein are merely exemplary and that a person skilled in the art may make many variations and modifications without departing from the spirit and scope of the invention. All such variations and modifications are intended to be included within the scope of the present invention as defined in the appended claims.

1. An illuminating display device adapted for enhancing amusement for a recipient, comprising a portable case having at least one compartment; at least one illuminating source received in said at least one compartment; a stencil for permitting light emitted from said at least one illuminating source to be transmitted therethrough in a predetermined pattern; and a dispersion layer for dispersing light emitted from said at least one illuminating source, said dispersion layer including a substrate coated at least partially with wax.

2. The device of claim 1, wherein said substrate includes a sheet made from paper soaked in wax.

3. The device of claim 2, wherein said at least one compartment includes a plurality of compartments separated from one another by a plurality of dividing members, said at least one illuminating source including a plurality of illuminating sources, each of which is positioned in one of said plurality of compartments.

4. The device of claim 3, wherein said stencil includes a plurality of first areas, each of which permits the passage of light therethrough, and at least one second area, which inhibits the passage of light therethrough, each of said first areas having a predetermined shape such that light emitting from said illuminating sources passes through said first areas in said predetermined fashion.

5. The device of claim 4, wherein each of said first areas of said stencil is aligned with one of said compartments such that light emitted from each of said illuminating sources passes through a corresponding one of said first areas.

6. The device of claim 5, wherein said compartments includes a first compartment and a set of second compartments, said first compartment receiving a set of said illuminating sources and being aligned with a set of first areas of said stencil such that light emitting from said set of said illuminating sources passes through said set of said first areas.

7. The device of claim 6, wherein each of said set of second compartments receives a corresponding one of a second set of said illuminating sources and aligned with a corresponding one of a second set of said first areas such that light emitting from each of said second set of said illuminating sources passes through a corresponding one of said second set of said first areas.

8. The device of claim 3, wherein said case includes a frame mounted therein, said dividing members being formed on said frame.

9. The display of claim 1, wherein said case is sized and shaped so as to be placed on a cake.
